(19) United States
(12) Patent Application Publication
(10) Pub. No.: US 2025/0173664 A1
(43) Pub. Date: May 29, 2025

(54) DELIVERY ASSISTANCE SYSTEM, DELIVERY ASSISTANCE METHOD, AND RECORDING MEDIUM

(71) Applicant: NEC Corporation, Minato- ku, Tokyo (JP)

(72) Inventors: Yosuke UMEDA, Tokyo (JP); Kohei SUGA, Tokyo (JP); Ruriko YANAI, Tokyo (JP); Ren NAKANO, Tokyo (JP)

(73) Assignee: NEC Corporation, Minato- ku, Tokyo (JP)

(21) Appl. No.: 18/834,421

(22) PCT Filed: Mar. 25, 2022
(86) PCT No.: PCT/JP2022/014288

§ 371 Date: Jul. 30, 2024

(51) Int. Cl. G06Q 10/083

(52) U.S. Cl. CPC G06Q 10/083

(57) ABSTRACT

A delivery assistance system comprising: a memory storing instructions; and at least one processor configured to execute the instructions to: acquire a condition value of each of a plurality of constraint conditions related to joint delivery; estimate an index value, of an index related to joint delivery, for the acquired condition value and an index value of the index in a case where the acquired condition value is changed for each of the plurality of constraint conditions; identify a constraint condition in which a variation of the estimated index values meets a predetermined criterion among the plurality of constraint conditions; and present the identified constraint condition and the variation of the index values to a user.

### TECHNICAL FIELD

The present disclosure relates to a delivery assistance system and the like.

### BACKGROUND ART

There is a joint delivery in which a plurality of consignors causes delivery means such as the same truck to carry and deliver load. In distribution, there are various constraint conditions such as a delivery date for delivering load.

For example, PTL 1 describes internal constraint conditions such as whether a delivery date can be changed, an arrival load amount, a vehicle class, the number of berths, the number of times of delivery, and whether mixed delivery can be performed. Furthermore, for example, PTL 1 describes that an internal constraint condition is changed and set in a plurality of various patterns, order placement information, consignor information, and a set internal constraint condition are acquired as input information, and an optimal joint delivery plan among possible joint delivery plans is obtained based on these pieces of input information.

### CITATION LIST

### Patent Literature

PTL 1: JP 2018-180893 A

### SUMMARY OF INVENTION

### Technical Problem

In the joint delivery, the degree of importance of the constraint condition varies depending on each player such as a consignor and a distribution company. Therefore, in the joint delivery, it may be necessary to adjust various constraint conditions of distribution among a plurality of players.

An object of the present disclosure is to provide a delivery assistance system or the like that facilitates adjustment of constraint conditions regarding joint delivery.

### Solution to Problem

A delivery assistance system according to an aspect of the present disclosure includes an acquisition means for acquiring a condition value of each of a plurality of constraint conditions related to joint delivery, an estimation means for estimating an index value, of an index related to joint delivery, for the acquired condition value and an index value of the index in a case where the acquired condition value is changed for each of the plurality of constraint conditions, an identification means for identifying a constraint condition in which a variation of the estimated index values meets a predetermined criterion among the plurality of constraint conditions, and an output control means for presenting the identified constraint condition and the variation of the index values to a user.

A delivery assistance method according to an aspect of the present disclosure includes acquiring a condition value of each of a plurality of constraint conditions related to joint delivery, estimating an index value, of an index related to joint delivery, for the acquired condition value and an index value of the index in a case where the acquired condition value is changed for each of the plurality of constraint conditions, identifying a constraint condition in which a variation of the estimated index values meets a predetermined criterion among the plurality of constraint conditions, and presenting the identified constraint condition and the variation of the index values to a user.

A program according to an aspect of the present disclosure causes a computer to execute the steps of acquiring a condition value of each of a plurality of constraint conditions related to joint delivery, estimating an index value, of an index related to joint delivery, for the acquired condition value and an index value of the index in a case where the acquired condition value is changed for each of the plurality of constraint conditions, identifying a constraint condition in which a variation of the estimated index values meets a predetermined criterion among the plurality of constraint conditions, and presenting the identified constraint condition and the variation of the index values to a user.

The program may be stored in a non-transitory computer-readable recording medium.

### Advantageous Effects of Invention

According to the present disclosure, it is possible to facilitate adjustment of constraint conditions regarding joint delivery.

### BRIEF DESCRIPTION OF DRAWINGS

FIG. 1 is a block diagram illustrating a configuration example of a delivery assistance system according to the first example embodiment.

FIG. 2 is a flowchart illustrating an operation example of the delivery assistance system according to the first example embodiment.

FIG. 3 is an explanatory diagram illustrating an example of joint delivery.

FIG. 4 is an explanatory diagram illustrating an example of connection between the delivery assistance system and another device.

FIG. 5 is a block diagram illustrating a configuration example of a delivery assistance system according to the second example embodiment.

FIG. 6 depicts an explanatory diagram illustrating an example in which a constraint condition and a change, and a variation of an index value are displayed.

FIG. 7 is an explanatory diagram illustrating an example of an expected load amount of load and an estimated number of trucks.

FIG. 8 is an explanatory diagram illustrating an example of the number of trucks in a case where part of load is delivered on a later date.

FIG. 9 is a flowchart illustrating an operation example of the delivery assistance system according to the second example embodiment.

FIG. 10 is an explanatory diagram illustrating an example of presenting a change in a constraint condition and an index value.

FIG. 11 is a flowchart illustrating another operation example of the delivery assistance system according to the second example embodiment.

FIG. 12 is an explanatory diagram illustrating a hardware configuration example of a computer.

### EXAMPLE EMBODIMENT

Hereinafter, example embodiments of a delivery assistance system, a delivery assistance method, a program, and a non-transitory recording medium recording the program according to the present disclosure will be described in detail with reference to the drawings. The present example embodiment does not limit the disclosed technology.

### First Example Embodiment

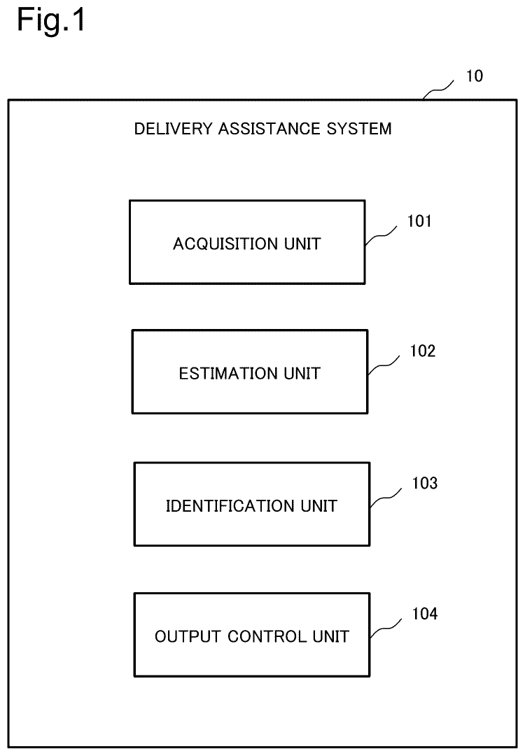

First, in the first example embodiment, a basic function of the delivery assistance system will be described. FIG. 1 is a block diagram illustrating a configuration example of the delivery assistance system according to the first example embodiment. A delivery assistance system 10 includes an acquisition unit 101, an estimation unit 102, an identification unit 103, and an output control unit 104.

The acquisition unit 101 acquires a condition value of each of a plurality of constraint conditions related to joint delivery. The joint delivery means that a plurality of consignors loads load on the same delivery means and cause the same delivery means to perform delivery. For example, the delivery means is not particularly limited, and examples thereof include a vehicle, a ship, an airplane, and a drone. The vehicle is not particularly limited, and examples thereof include a truck and a bicycle.

The constraint conditions are items such as a delivery course, a lead time, a delivery date and time, a reservation date and time of a berth, a type of load, a load appearance, and the number of berths. The expression method of the condition value of the constraint condition may be different depending on the constraint condition, and is not particularly limited. For example, in a case where the constraint condition is the delivery course, the condition value of the constraint condition is a condition value that affects the delivery distance, the fuel, the usage fee of traffic, and the like. Specifically, the condition value of the constraint condition may be “via xx base”, “via yy road”, “high speed priority”, or the like.

The delivery date and time is a delivery date and time when the load arrives at the destination. In a case where the constraint condition is a date specification within the delivery date and time, the condition value of the constraint condition may be a specific date such as “February 15”. In a case where the constraint condition is a time specification within the delivery date and time, the condition value of the constraint condition is “designated in the morning”, “designated in the afternoon”, “not designated”, “15:00”, or the like.

The reservation date and time of the berth is a date and time when a berth to be described later is used. In a case where the constraint condition is a reservation date and time of the berth, the condition value of the constraint condition is a specific time such as “9:00” or a date and time such as “February 15 9:00”.

The type of load is, for example, an “electrical appliance”, a “food”, a “fragile object”, and the like, and is not particularly limited. Depending on the type of load, an odor may be attached to another load at the time of joint delivery. For example, it is necessary to avoid that an odor of a tire of a car or the like adheres to food. For this reason, in a case where the constraint condition is the type of load, in a case where the type of load is food, joint delivery is performed with load whose odor does not adheres the food.

The load appearance represents, for example, an appearance of load at the time of delivery. In a case where the constraint condition is a load appearance, the condition value of the constraint condition is a “wood pallet”, a “container”, a “metal barrel”, a “cardboard”, or the like.

The berth is a space used for loading and unloading load and the like. In a case where the constraint condition is the number of berths, the condition value of the constraint condition is a specific numerical value such as “1”, “2”, or “3”. The condition value of the number of berths can be changed. However, in general, the date and time of using the berth is changed instead of changing the condition value of the number of berths. A case where the company X and the company Y are consignors and destinations will be described as an example. In this case, the number of berths is the number of berths held by each of the company X and the company Y. For example, it is assumed that the distribution company E performs the delivery to the company X at the reservation date and time “9:00” of the berth, and performs the delivery to the company Y at the reservation date and time “10:00” of the berth. In such a case, the reservation date and time of the berth of the distribution company E that satisfies the constraint conditions of both the company X and the company Y is “9:00”. However, in a case where the distribution company F uses the berth to carry out the delivery to the company X at the reservation date and time “9:00” of the berth, the distribution company E cannot use the berth until the reservation date and time “9:30” of the berth for the delivery to the company X. In such a case, delivery to the company Y is not allowed in time. Therefore, the delivery to the company Y by the distribution company E is enabled by changing the reservation date and time of the berth of the distribution company F to “10:00”.

For example, the acquisition unit 101 may acquire the condition value of each of the plurality of constraint conditions received in advance by the operation by the consignor from a database or the like. Alternatively, for example, the acquisition unit 101 may receive the condition value of each of the plurality of constraint conditions by the operation by the consignor. More specifically, for example, the acquisition unit 101 may receive the condition value of each of the plurality of constraint conditions via the terminal device of the consignor by the operation by the consignor.

The estimation unit 102 estimates an index value of an index related to the joint delivery for the acquired condition value and an index value of the index in a case where the acquired condition value is changed for each of the plurality of constraint conditions. The range to be changed from the acquired condition value may be the acquired allowable degree. The consignor whose condition value of the constraint condition is changed is not particularly limited. For example, the consignor whose condition value of the constraint condition is changed may be a specific consignor. For example, the consignor whose condition value of the constraint condition is changed may be a consignor whose condition value of the constraint condition is estimated to have a large influence on the effect in the joint delivery. For example, the consignor whose condition value of the constraint condition is changed may be all the consignors.

As a method of deriving a combination of load loaded on each delivery means of joint delivery that satisfies the acquired condition value of the constraint condition, any existing technology can be used. As this method, for example, a plurality of patterns of combinations of load to be loaded is randomly generated, and it is determined whether each pattern satisfies the condition value of the constraint condition, so that a pattern satisfying the condition value may be derived. A method of deriving a combination of load loaded on each delivery means of the joint delivery in a case where the condition value acquired for each of the plurality of constraint conditions is changed can similarly adopt any existing technology, and thus, a detailed description thereof will be omitted. The estimation unit 102 may derive a combination of load loaded on each delivery means of joint delivery, or the acquisition unit 101 may acquire each combination derived by another device. In a case where the joint delivery is not established, the output control unit 104 may present the condition value of the constraint condition that has caused the non-establishment. For example, in a case where the joint delivery is not established due to the load appearance, the output control unit 104 presents the load appearance condition value.

The index related to the joint delivery is, for example, at least one of the number of delivery means, the delivery cost, the delivery distance, the time required for the delivery, and the carbon dioxide emission amount. For example, the index is an index indicating an effect in the joint delivery. For example, in a case where the delivery means is a truck, the number of delivery means is the number of vehicles. For example, in a case where the delivery means is a truck, the delivery distance is a travel distance. For example, in a case where a plurality of tracks is used, the delivery distance may be a delivery distance for each track, may be a statistical delivery distance such as an average delivery distance of one track, or may be a total delivery distance. For example, the delivery cost is a cost required for delivery such as a fuel cost and a charging cost. For example, in a case where the delivery means is a truck and a plurality of tracks is used, the delivery cost may be a statistical cost such as an average cost of one truck, or may be a total cost of the plurality of tracks.

The carbon dioxide emission amount is also an index for measuring an influence on the environment. Carbon dioxide will be described as an example, but another substance that may affect the environment may be used. Examples of another substance include, but are not particularly limited to, methane and dinitrogen monoxide which are greenhouse gases other than carbon dioxide. In the following description, carbon dioxide may be referred to as CO₂. In the following description, there is a case where the carbon dioxide emission amount is abbreviated as an emission amount, and the carbon dioxide reduction amount is abbreviated as a reduction amount.

The index may be estimated by date, by a plurality of days, by one week, or the like.

For each constraint condition, the degree to which the condition value of the constraint condition is changed is not particularly limited. For example, the condition value of the constraint condition is changed to a condition value that facilitates joint delivery. Taking a case where the constraint condition is the delivery date and time as an example, as an example of changing to a condition value that facilitates joint delivery, in a case where the condition value of the delivery date and time is “designated in the morning”, the condition value is changed to “not designated”.

The condition value of the constraint condition that cannot be changed, such as the type of load, the load appearance, and the like, is not changed.

As a technique by which the estimation unit 102 estimates the index value of each index, an existing technique may be used. The acquisition unit 101 may acquire each piece of information used to estimate the index value of each index.

For example, the method of calculating the carbon dioxide emission amount is not particularly limited as long as existing techniques such as a ton-kilometer method using multiplication of a weight of load and a transport distance, a fuel method using a fuel consumption amount, and a fuel consumption method using a transport distance and fuel consumption are used.

The identification unit 103 identifies a constraint condition in which the variation of the estimated index value meets a predetermined criterion. The variation of the index value here is a variation between the index value of the index in a case where the acquired condition value is not changed and the index value of the index after the change. Specifically, for example, the variation of the index value may be represented by a difference between the index value for the acquired condition value and the changed index value. Alternatively, the variation of the index value may be a ratio of a change in the index value after the change to the index value for the acquired condition value. A method of expressing the variation of the index value may be different depending on the index, for example. For example, in a case where the index is the number of vehicles, the variation of the index value may be represented by the increased or decreased number of vehicles. In a case where the index is the delivery cost, the variation of the index value may be represented by an increased or decreased fee. For example, in a case where the index is a carbon dioxide emission amount, the variation of the index value may be represented by a reduction ratio.

The predetermined criterion may be determined in advance by an index. The predetermined criterion is a condition for narrowing down constraint conditions to be presented. The predetermined criterion may be different depending on whether the user needs to confirm that the effect of the joint delivery is high or the user needs to confirm that the effect of the joint delivery is low. The predetermined criterion may be a condition that the user needs to confirm that the effect of the joint delivery is less affected by the user. The user here may be a user as a consignor or a user as a distribution company. Hereinafter, the user as a consignor may be abbreviated as a consignor and the user of as distribution company may be abbreviated as a distribution company.

For example, in a case where the index is the number of vehicles and it is desired to present a change in the constraint condition having a high effect of joint delivery, the predetermined criterion may be that the number of vehicles has decreased by a predetermined number or more. For example, in a case where the index is the number of vehicles and it is desired to present a change in a constraint condition having a low effect of joint delivery, the predetermined criterion may be that the number of vehicles has increased by a predetermined number or more. For example, in a case where the index is the number of vehicles and it is desired to present a change in the constraint condition that does not affect the effect of the joint delivery, the predetermined criterion may be that the variation is equal to or less than the predetermined number of vehicles.

For example, in a case where the index is the delivery cost, and it is desired to present a change in the constraint condition having a high effect of the joint delivery, the predetermined criterion may be that the cost has decreases by a predetermined fee or more. For example, in a case where the index is the delivery cost and it is desired to present a change in the constraint condition with a low effect of the joint delivery, the predetermined criterion may be that the cost has increased by a predetermined fee or more. For example, in a case where the index is the delivery cost and it is desired to present a change in the constraint condition that does not affect the effect of the joint delivery, the predetermined criterion may be that the variation is equal to or less than a predetermined fee.

For example, in a case where the index is the carbon dioxide emission amount, the variation is the reduction amount, and it is desired to present a change in the constraint condition having a high effect of joint delivery, the predetermined criterion may be that the reduction amount is equal to or more than a predetermined amount. For example, in a case where the index is the carbon dioxide emission amount, the variation is the reduction amount, and it is desired to present the change in the constraint condition having a low effect of the joint delivery, the predetermined criterion may be that the reduction amount is equal to or less than a predetermined amount, or may be a negative value. A negative value of the reduction amount indicates that the emission amount has increased.

The output control unit 104 presents the identified constraint condition and the variation of the index values to a user. For example, a method by which the output control unit 104 presents to the consignor the identified constraint condition and the variation of the index value is not particularly limited. As a specific presentation method, the output control unit 104 may notify the user of the identified constraint condition and the variation using an electronic message, an electronic mail, or the like. Alternatively, as another presentation method, the output control unit 104 may output the identified constraint condition and the variation to the terminal device of the user. Specifically, for example, the output control unit 104 may display, for example, the identified constraint condition and the variation on the display device of the terminal device of the user. Alternatively, the output control unit 104 may output, for example, the identified constraint condition and the variation by voice to the audio output device of the terminal device of the user.

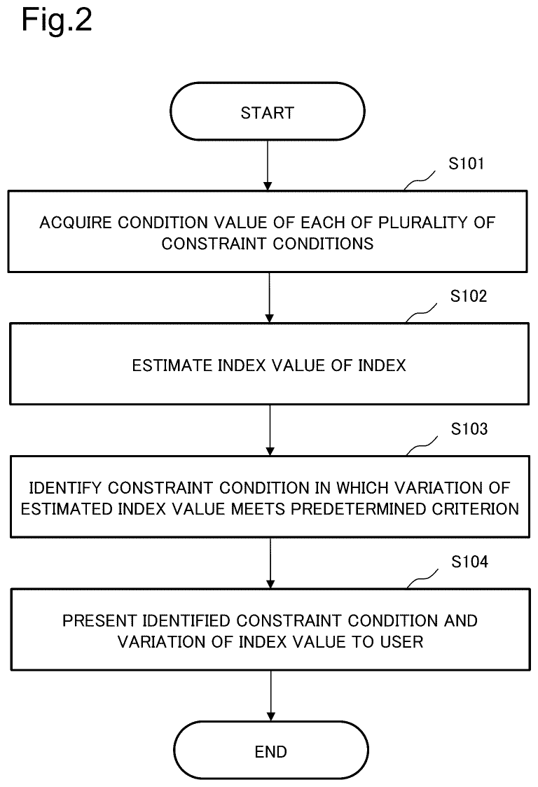

FIG. 2 is a flowchart illustrating an operation example of the delivery assistance system 10 according to the first example embodiment. The acquisition unit 101 acquires the condition value of each of the plurality of constraint conditions (step S101). The estimation unit 102 estimates an index value of the index related to the joint delivery in a case where the condition value is changed from the acquired condition value and an index value of the index in a case where the condition value is changed from the acquired condition value for each of the plurality of constraint conditions (step S102).

The identification unit 103 identifies a constraint condition in which the variation of the estimated index value meets a predetermined criterion (step S103). The output control unit 104 presents the identified constraint condition and the variation of the index values to a user (step S104).

As described above, in the first example embodiment, the delivery assistance system 10 estimates the index value of the index in a case where the condition value of the constraint condition is changed for each constraint condition, identifies the constraint condition in which the variation of the index value meets the predetermined criterion, and presents the constraint condition and the variation of the index value to the user. As a result, it is possible to propose a change in the constraint condition having a high effect in the joint delivery. Therefore, it is possible to facilitate adjustment of the constraint conditions.

### Second Example Embodiment

Next, the second example embodiment will be described in detail with reference to the drawings. In the second example embodiment, an example in which the constraint conditions are further narrowed down and an example in which the constraint conditions are presented will be described in detail with specific examples. In the second example embodiment, a case where the delivery means is a truck will be described as an example. In the second example embodiment, an example will be described in which the amount of load of each consignor is acquired for each delivery date, and the index value in a case where the time zone of delivery of the load is changed is estimated. Hereinafter, description of content overlapping with the above description will be omitted to the extent that the description of the second example embodiment is not unclear.

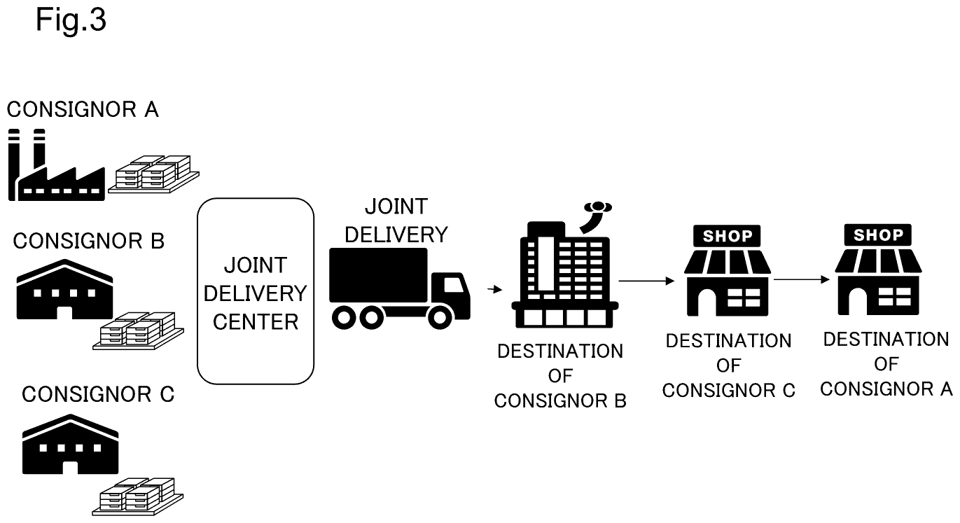

FIG. 3 is an explanatory diagram illustrating an example of joint delivery. For example, in FIG. 3, in a joint delivery center, a distribution company collects and delivers load from each of a plurality of consignors. In the example of FIG. 3, a distribution company having a consignor A, a consignor B, and a consignor C as consignors loads and delivers load collected and delivered from each of a plurality of consignors on the same truck. This delivery is joint delivery. The truck delivers load to a destination of the load of each consignor. The destinations of the load of each consignor may be the same. The destination is not limited to a specific destination, and may be a destination direction or the like. The destination here is not limited to the final destination, and may be a transit point on the way.

The joint delivery of FIG. 3 is an example, and for example, a joint delivery such as a milk run method in which load is collected from a plurality of companies and delivered by one truck may be used.

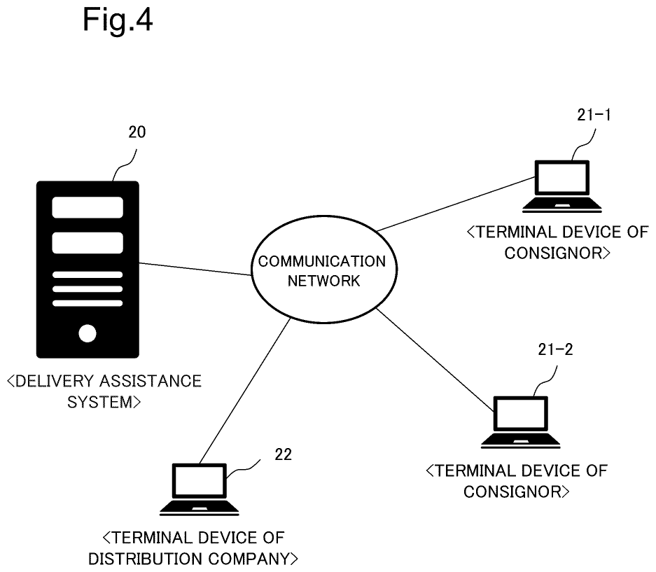

FIG. 4 is an explanatory diagram illustrating an example of connection between the delivery assistance system and another device. For example, a delivery assistance system 20 is connected to a terminal device 21 or the like of each consignor via a communication network NT. The delivery assistance system 20 is connected to a terminal device 22 or the like of a distribution company via the communication network NT.

In FIG. 4, one communication network NT is exemplified for ease of description, but the delivery assistance system 20 may be connected by different communication networks NT for each device, and is not particularly limited.

Although FIG. 4 illustrates a terminal device 21-1 of the consignor and a terminal device 21-2 of the consignor, the terminal device 21 of the consignor may be provided for each consignor, and the number of terminal devices 21 of the consignor is not particularly limited. In a case where the terminal device 21 of the consignor is not uniquely identified, it is simply described as a terminal device. The type of the terminal device 21 of the consignor is not particularly limited as in a smartphone, a tablet-type device, and a personal computer (PC).

In FIG. 4, a case where the number of terminal devices 22 of the distribution company is one is taken as an example, but the number of terminal devices 22 of the distribution company is not particularly limited.

Although it is assumed that the number of distribution companies is one, the number of distribution companies is not particularly limited. For example, a distribution company may operate a platform that implements the delivery assistance system 20 in each example embodiment. Alternatively, the platform that implements the delivery assistance system 20 according to each example embodiment may be provided to one or a plurality of distribution companies.

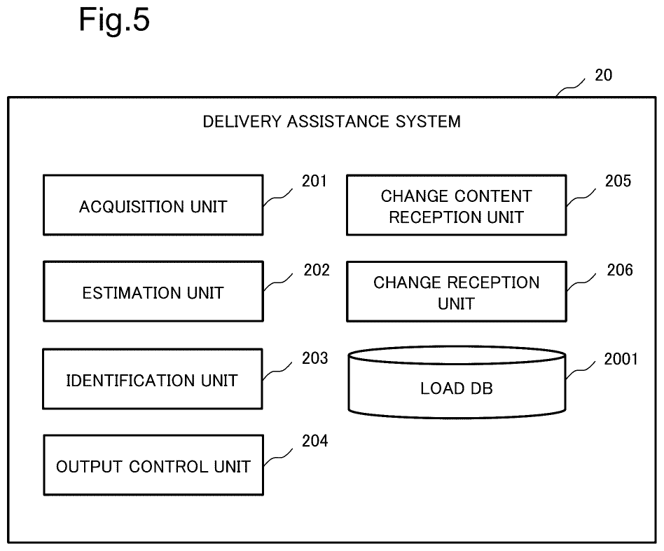

FIG. 5 is a block diagram illustrating a configuration example of the delivery assistance system 20 according to the second example embodiment. The delivery assistance system 20 includes an acquisition unit 201, an estimation unit 202, an identification unit 203, an output control unit 204, a change reception unit 205, and a change content reception unit 206. The delivery assistance system 20 according to the second example embodiment is different from the delivery support system according to the first example embodiment in that it further includes the change reception unit 205 and the change content reception unit 206.

The acquisition unit 201 has the function of acquisition unit 101 according to the first example embodiment as a basic function. The estimation unit 202 may have the function of the estimation unit 102 according to the first example embodiment as a basic function. The identification unit 203 may have the function of the identification unit 103 according to the first example embodiment as a basic function. The output control unit 204 may have the function of the output control unit 104 according to the first example embodiment as a basic function.

The delivery assistance system 20 includes a load database (DB) 2001. The load DB 2001 stores information about load for each load. For example, the load DB 2001 stores load identification information for identifying load, a destination of the load, an amount of the load, and consignor identification information for identifying a load consignor in association with each other. The load identification information for identifying load is not particularly limited as long as the load e can be uniquely identified. The consignor identification information for identifying the consignor is not particularly limited as long as the consignor can be uniquely identified. The destination of the load is not limited to a specific destination, and may be a destination direction or the like. The destination here is not limited to the final destination, and may be a transit point on the way. The type of the amount of load e may vary depending on the characteristics of the load e, and the amount representing the space occupied by the load, the amount representing the weight of the load, a combination thereof, and the like are not particularly limited. For example, as the amount of load such as a steel material, an amount representing the weight of the load is used. In a case where the amount of load is an amount representing a space occupied by the load, the unit of the amount of load may be an existing unit such as a volume, the number of specific packages, or the like, and is not particularly limited. In a case where the amount of load e is an amount representing the weight of load e, the unit of the amount of load may be an existing unit such as weight, and is not particularly limited.

Next, each function unit will be described. For each function unit, an example of presenting a highly effective change in the constraint condition and an example of presenting the index value of each index in a comparable manner between a case where the condition value of the constraint condition is changed and a case where the condition value of the constraint condition is not changed will be described.

### <Example of Presenting Change in Condition Value of Constraint Condition in Joint Delivery>

First, an example of presenting a change in a condition value of a constraint condition in joint delivery will be described.

The acquisition unit 201 acquires a condition value of each of a plurality of constraint conditions related to joint delivery. For example, the acquisition unit 201 acquires a condition value of each of a plurality of constraint conditions regarding the joint delivery for each consignor. The acquisition unit 201 may acquire an allowable degree of change in the condition value of the constraint condition for each consignor.

The method by which the acquisition unit 201 acquires each piece of information of the consignor is as described above. For example, the acquisition unit 201 may acquire information received in advance by the operation by the consignor from a database or the like. Alternatively, for example, the acquisition unit 201 may newly receive information by the operation by the consignor. More specifically, for example, the acquisition unit 201 newly receives information via the terminal device 21 of the consignor by the operation by the consignor.

The acquisition unit 201 may further acquire information necessary for estimation of the index value by the estimation unit 202.

The estimation unit 202 estimates an index value of an index related to the joint delivery for the acquired condition value and an index value of the index in a case where the acquired condition value is changed for each of the plurality of constraint conditions. As described in the first example embodiment, the combination of load to be loaded on each delivery means of the joint delivery that satisfies the acquired condition value of the constraint condition and the like may be derived using any existing technology using the load DB 2001 and the like as described above. The combination of load to be loaded on each delivery means of the joint delivery in a case where the condition value acquired for each of the plurality of constraint conditions is changed may be similarly derived using any existing technology using the load DB 2001 or the like. Detailed description of these derivation methods will be omitted.

Specifically, for example, the estimation unit 202 estimates an index value of an index related to the joint delivery for the acquired condition value. Next, the estimation unit 202 selects a constraint condition that is not selected from a plurality of constraint conditions for a specific consignor, changes the condition value of the selected constraint condition from the acquired condition value, and estimates the index value of the index in a case where the condition values of the other constraint conditions are the acquired condition value. The estimation unit 202 may repeat such processing until there is no unselected constraint condition for the plurality of constraint conditions.

For example, in a case where the index is the carbon dioxide emission amount, the estimation unit 202 calculates a carbon dioxide emission amount before changing the condition value of the constraint condition and a carbon dioxide emission amount after changing the condition value for each of the plurality of constraint conditions.

As an example of changing the condition value of the constraint condition, a case where the condition value of the delivery date and time and the condition value of the delivery course are changed will be described as an example. For example, the estimation unit 202 calculates three types of carbon dioxide emission amounts: a carbon dioxide emission amount before changing the condition value of the constraint condition, a carbon dioxide emission amount in a case of changing the condition value of the delivery date and time, and a carbon dioxide emission amount in a case of changing the condition value of the delivery course.

For example, the estimation unit 202 may calculate the variation of the index value. For example, in a case where the index is a carbon dioxide emission amount, the estimation unit 202 derives a reduction amount of the carbon dioxide emission amount before and after the change in the condition value of the constraint condition as a variation of the index value based on the calculated carbon dioxide emission amount.

As an example of changing the condition value of the constraint condition described above, a case where the condition value of the delivery date and time and the condition value of the delivery course are changed will be described as an example. For example, the estimation unit 202 calculates a carbon dioxide reduction amount in a case of changing the condition value of the delivery date and time based on a carbon dioxide emission amount before changing the condition value of the constraint condition, and a carbon dioxide emission amount in a case of changing the condition value of the delivery date and time. The estimation unit 202 calculates the carbon dioxide reduction amount in a case where the condition value of the delivery course is changed based on the carbon dioxide emission amount before the condition value of the constraint condition is changed and the carbon dioxide emission amount in a case where the condition value of the delivery course is changed.

The identification unit 203 identifies a constraint condition in which the estimated variation of the index values meets a predetermined criterion. For example, in a case where the index is the carbon dioxide emission amount, the identification unit 203 identifies a constraint condition in which the reduction amount meets a predetermined criterion from a plurality of constraint conditions. For example, the predetermined criterion may be that the reduction amount is equal to or more than 2%. In this case, the identification unit 203 identifies the constraint condition in which the reduction amount after changing the condition value of the constraint condition is equal to or more than 2% from the plurality of constraint conditions.

As an example of changing the condition value of the constraint condition described above, a case where the condition value of the delivery date and time and the condition value of the delivery course are changed will be described as an example. It is assumed that the carbon dioxide reduction amount in a case where the condition value of the delivery date and time is changed is 3%, and the carbon dioxide reduction amount in a case where the condition value of the delivery course is changed is 0.5%. In this case, the identification unit 203 identifies the delivery date and time resulting in a change in which the reduction amount is equal to or more than 2%.

The output control unit 204 presents the identified constraint condition and the variation of the index values to a user. As described in the first example embodiment, the user may be a person of a distribution company or a consignor.

For example, a plurality of constraint conditions may be identified. In such a case, the output control unit 204 may present the constraint conditions and the variations of the index values side by side in a predetermined order. The predetermined order may be the descending order of the effect of the joint delivery or the ascending order of the effect of the joint delivery, and is not particularly limited. For example, the relationship between the level of the effect of the joint delivery and the variation of the index value varies depending on the index. For example, the variation of the index value includes a variation of a decrease and a variation of an increase. The greater the variation in the decrease, the greater the effect of joint delivery may be. On the other hand, the greater the variation in increase, the higher the effect of joint delivery may be.

For example, in a case where the index is the number of vehicles, the larger the decrease in the number of vehicles, the higher the effect of the joint delivery. For example, in a case where the index is the delivery cost, the larger the decrease in the delivery cost, the higher the effect of the joint delivery. For example, in a case where the index is a carbon dioxide emission amount, the larger the reduction amount, the higher the effect of joint delivery. Therefore, in a case where the constraint condition having a high effect of the joint delivery is presented, for example, the output control unit 204 may present the constraint condition and the variation side by side in descending order of the variation in decrease. In a case where the constraint condition having a low effect of the joint delivery is presented, for example, the output control unit 204 may present the constraint condition and the variation side by side in descending order of the variation in increase.

On the other hand, a case where the greater the variation in increase, the higher the effect of joint delivery is, will be taken as an example. In a case where the constraint condition having a high effect of the joint delivery is presented, for example, the output control unit 204 may present the constraint condition and the variation side by side in descending order of the variation in increase. In a case where the constraint condition having a low effect of the joint delivery is presented, for example, the output control unit 204 may present the constraint condition and the variation side by side in descending order of the variation in decrease. The arrangement is not particularly limited. For example, the output control unit 204 may present the constraint condition and the variation side by side together with the order.

Alternatively, the output control unit 204 may present a predetermined number of constraint conditions and the variations selected according to the variations among the identified constraint conditions. The predetermined number is an integer of one or more. The predetermined number may be designated by the user or may be determined in advance. For example, when the predetermined number is one, the output control unit 204 can present the constraint condition and the variation having the highest joint delivery effect. Alternatively, when the predetermined number is one, the output control unit 204 can present the constraint condition and the variation having the lowest joint delivery effect. In this manner, the output control unit 204 can narrow down the number of constraint conditions to be presented.

The output control unit 204 may narrow down the number of constraint conditions to be presented and present the constraint conditions in a predetermined order. The processing by the output control unit 204 may be appropriately combined.

The change reception unit 205 receives the change in the condition value of the identified constraint condition by the user. For example, when receiving the change, the change reception unit 205 updates the condition value of the constraint condition stored in the database to the changed condition value.

For example, in a case where the user is a consignor, the consignor checks whether the change is an allowable change. For example, the output control unit 204 may present the acquired allowable degree for the constraint condition together with the identified constraint condition. When the user can permit the change, the change reception unit 205 receives the change in the condition value of the constraint condition identified by the operation by the consignor via the terminal device 21 of the consignor.

For example, in a case where the user is a distribution company, the distribution company checks whether the change is a change the consignor can permit. For example, the output control unit 204 may present the acquired allowable degree for the identified constraint condition. For example, in a case where the change is a change the consignor can permit, the change reception unit 205 receives a change in the condition value of the constraint condition identified by the operation of the distribution company via the terminal device 22 of the distribution company. In a case where the change reception unit 205 receives the change in the condition value of the constraint condition by the distribution company, the output control unit 204 notifies the consignor of the change in the condition value of the constraint condition. The notification method is not particularly limited, and examples thereof include an electronic message and an e-mail.

### (Example of Changing Plural Condition Values of Constraint Condition)

There may be a plurality of changes in the condition value of each constraint condition. Therefore, the estimation unit 202 estimates the index value of the index for each of one or more changes for each of the plurality of constraint conditions. A case where the condition value of the delivery date and time is changed among the plurality of constraint conditions will be described as an example. In a case where the acquired condition value of the delivery date and time is “designated in the morning”, examples of the change in the condition value include a case where “designated in the morning” is changed to “not designated” and a case where “designated in the morning” is changed to “designated in the afternoon”. Therefore, the estimation unit 202 estimates the index value for each of a case where “designated in the morning” is changed to “not designated” and a case where “designated in the morning” is changed to “designated in the afternoon”.

The identification unit 203 identifies a constraint condition and a change whose index value is a predetermined criterion among the plurality of constraint conditions and changes.

The output control unit 204 presents the identified constraint condition and change and the index value of each index in the constraint condition and change to the user. As described above, the output control unit 204 may present the constraint conditions and changes to be presented in a predetermined order. As described above, the output control unit 204 may narrow down and present the number of constraint conditions and changes to be presented.

An example in which the output control unit 204 displays, on the display device, the identified constraint condition and change and the index value of each index for the constraint condition and change will be described. The display device may be provided in the terminal device 22 of the distribution company or may be provided in the terminal device 21 of the consignor.

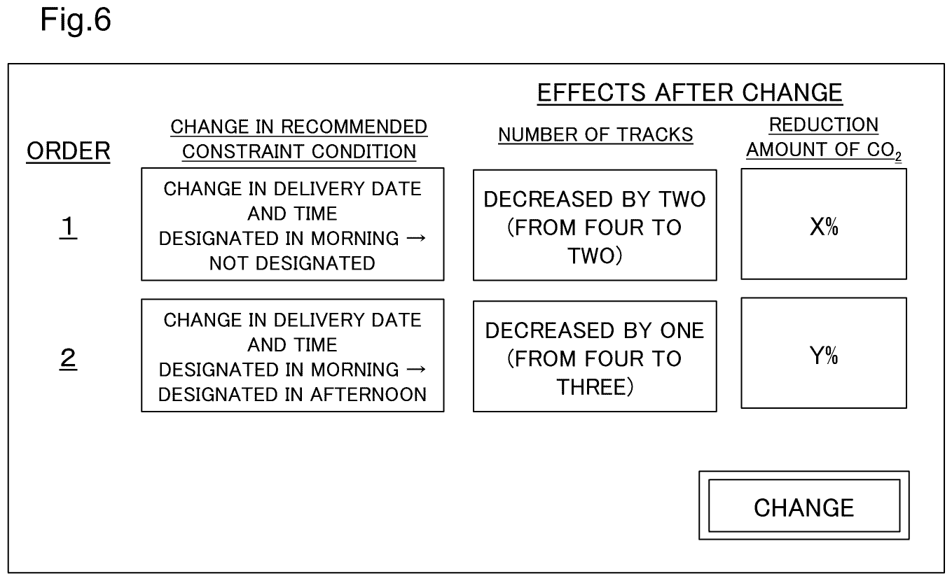

FIG. 6 is an explanatory diagram illustrating an example in which a constraint condition and a change and a variation of an index value are displayed. In FIG. 6, the number of trucks and the reduction amount of CO₂ are displayed on the screen as the variations of the index. In FIG. 6, the constraint conditions and changes are displayed on the screen in descending order of decrease in the number of tracks. In FIG. 6, this order is displayed on the screen.

For example, in a case where the decrease in the number of trucks is the largest, the constraint condition is the delivery date and time, and the change in the condition value of the constraint condition is from “designated in the morning” to “not designated”. In this case, the number of trucks as an index is four to two, the number of reduced trucks is two, and the carbon dioxide reduction amount as an index is X %.

Next, for example, in a case where the decrease in the number of trucks is large, the constraint condition is the delivery date and time, and the change in the condition value of the constraint condition is from “designated in the morning” to “designated in the afternoon”. In this case, the number of trucks as an index is four to three, the number of reduced trucks is one, and the carbon dioxide reduction amount as an index is Y %.

For example, in FIG. 6, it is assumed that respective changes of “change in recommended constraint condition” can be selected. In FIG. 6, the screen has a “change” button. For example, in FIG. 6, when any change is selected and the “change” button is pressed, the change reception unit 205 receives the selected change.

As described above, in a case where the user is a distribution company, in a case where the change reception unit 205 receives the change, the output control unit 204 notifies the consignor of the change.

### (Example of Changing a Time Zone of Delivery of at Least Part of Load)

Next, an example of changing the delivery time zone of at least part of load in a case where the time zone of delivery is changed will be described using the delivery date and time as an example as the constraint condition. The unit of the time zone to be changed is not particularly limited, and may be a fixed time unit in one day, a date unit, or a unit of a plurality of days. A description will be given using a date unit as an example of the unit of the time zone to be changed. For example, the amount of load varies from day to day. Meanwhile, there is also an upper limit to the number of delivery means that can be prepared by the distribution company. The upper limit number of delivery means is a constraint condition of the distribution company. It is difficult to change the upper limit number of delivery means. Therefore, the delivery date of part of load may be changed, and the index value of each index may be estimated.

For example, the acquisition unit 201 acquires the expected amount of load e for each deliverable date from each consignor participating in the joint delivery. As described above, the type of the amount of load may be different according to the characteristics of the load.

The range of dates on which the expected amount of load is acquired is not particularly limited, such as several days, one week, several weeks, and one month.

The estimation unit 202 estimates an index value of an index in a case where delivery is performed with the acquired amount of load for each deliverable date. For each deliverable date, the estimation unit 202 estimates an index value of an index in a case where a time zone in which at least part of load of a specific date is delivered is changed for a constraint condition of a delivery date and time among a plurality of constraint conditions. The specific date may be a date when the total amount of load is large, a date when the total amount of load is small, or a designated date, and is not particularly limited. The specific date may also be a plurality of dates. The amount of load in which the time zone can be changed may be determined in advance as an allowable condition value of the constraint condition for each consignor, and may be acquired by the acquisition unit 201. As described above, in the following examples, an example in which the date unit is used as the unit of the time zone to be changed will be described.

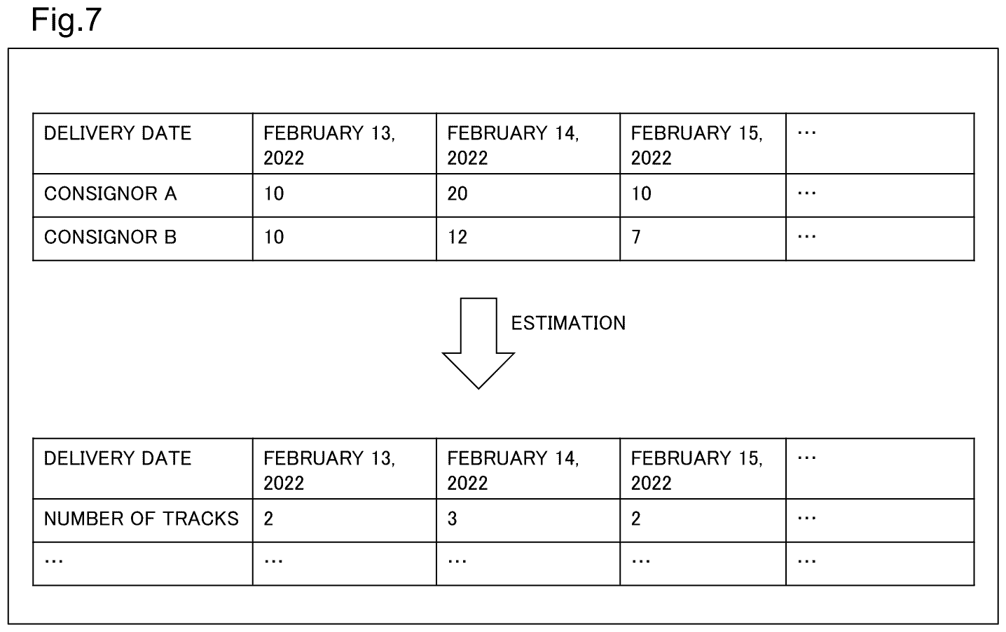

FIG. 7 is an explanatory diagram illustrating an example of the expected amount of load and the estimated number of trucks. FIG. 7 illustrates the expected amount of load for each deliverable date for each consignor. In FIG. 7, an example in which the amount of load is represented by the number of load is used.

For example, the amount of load of the consignor A is 10 on Feb. 13, 2022, 20 on Feb. 14, 2022, and 10 on Feb. 15, 2022.

For example, the amount of load of the consignor B is two on Feb. 13, 2022, two on Feb. 14, 2022, and three on Feb. 16, 2022.

For example, it is assumed that the upper limit number of trucks, which is a constraint condition of the distribution company, is three every day. It is assumed that up to 15 pieces of load can be loaded per truck.

In a case where joint delivery is performed with the amount of load acquired by the consignor A and the consignor B, the total amount of expected load is 20 on Feb. 13, 2022, and thus the number of trucks is expected to be two. On Feb. 14, 2022, since the total amount of expected load is 32, the number of trucks is expected to be 3. Since the total amount of expected load is 17 on Feb. 15, 2022, the number of trucks is expected to be two.

For example, the amount of load on Feb. 14, 2022 is large. For example, the estimation unit 202 estimates the index value in a case where part of the load on Feb. 14, 2022 is changed to that on Feb. 15, 2022.

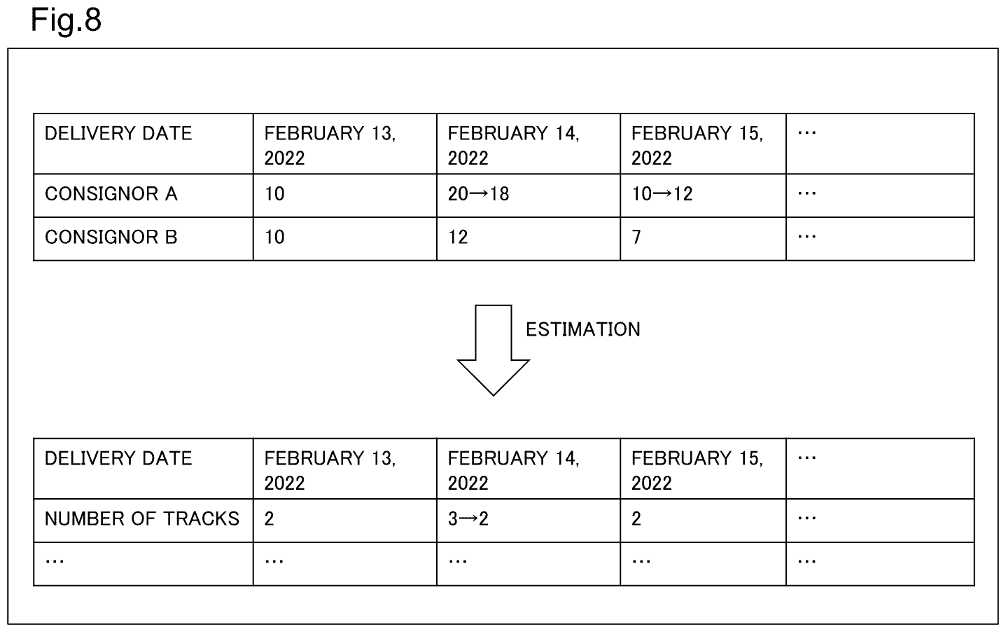

FIG. 8 is an explanatory diagram illustrating an example of the number of trucks in a case where part of load is delivered on a later date. In the example of FIG. 8, it is assumed that two pieces of load of Feb. 14, 2022 are delivered on Feb. 15, 2022.

For example, for Feb. 13, 2022, since the total amount of expected load is 20, which is the same as that before the change, the number of trucks is expected to be two. For example, since the total amount of load after the change on Feb. 14, 2022 is 30, the number of trucks is expected to be two. Since the total amount of expected load is 17 on Feb. 15, 2022, the number of trucks is expected to be two. Thus, the number of trucks on February 14 decreases.

The identification unit 203 determines whether the variation of the index value satisfies a predetermined criterion due to the change in the delivery date and time. For example, in a case where a predetermined criterion is that the number of reduced trucks is one or more, since the number of trucks on February 14 is reduced by one, the identification unit 203 identifies a change in the date of part of the load on February 14.

The output control unit 204 may present the identified change and the variation of the index value. In the examples of FIGS. 7 and 8, a change in which two pieces among load of the consignor A on Feb. 14, 2022 are delivered on Feb. 15, 2022, and one that is the reduced number of trucks are presented.

### (Flowchart Example)

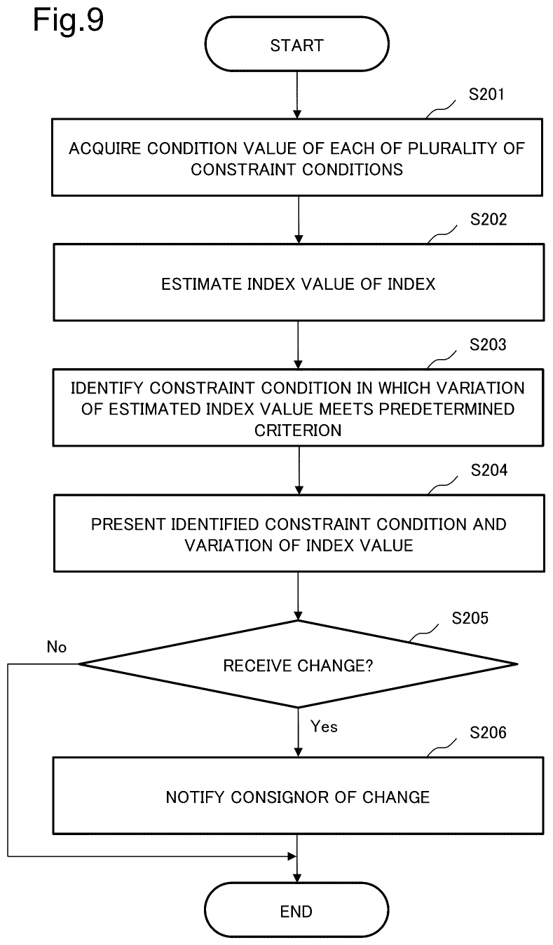

FIG. 9 is a flowchart illustrating an operation example of the delivery assistance system 20 according to the second example embodiment. A case where the user is a distribution company and a change by the distribution company is received will be described as an example.

The acquisition unit 201 acquires the condition value of each of the plurality of constraint conditions (step S201). In step S201, the acquisition unit 201 may further acquire information necessary for estimating the index value of each index.

Next, the estimation unit 202 estimates the index value of the index for the acquired condition value and the index value of the index in a case where the acquired condition value is changed for each of the plurality of constraint conditions (step S202). In step S202, for example, the estimation unit 202 may select a constraint condition that is not selected from a plurality of constraint conditions, change the condition value of the selected constraint condition from the acquired condition value, and estimate the index value of the index in a case where the condition values of the other constraint conditions are the acquired condition value. The estimation unit 202 may repeat such processing until there is no unselected constraint condition for the plurality of constraint conditions.

The identification unit 203 identifies a constraint condition in which the variation of the estimated index value meets a predetermined criterion (step S203). Next, the output control unit 204 presents the identified constraint condition and the variation of the index value to the terminal device 22 of the distribution company (step S204).

The change reception unit 205 determines whether the change in the condition value of the identified constraint condition has been received (step S205). In step S205, for example, the change reception unit 205 determines whether the change in the condition value of the constraint condition by the distribution company has been received via the terminal device 22 of the distribution company.

In a case where the change reception unit 205 receives the change (step S205: Yes), the output control unit 204 notifies the consignor of the change (step S206). The delivery assistance system 20 ends the process. On the other hand, in a case where the change reception unit 205 has not received the change (step S205: No), the delivery assistance system 20 ends the process.

As described above, in the second example embodiment, the delivery assistance system 20 estimates the index value of the index related to the joint delivery in the condition value of each of the plurality of constraint conditions related to the joint delivery and the index value of the index in a case where the acquired condition value is changed for each of the plurality of constraint conditions. The delivery assistance system 20 identifies a constraint condition under which a variation of the estimated index value meets a predetermined criterion, and presents the identified constraint condition and the variation to the user. It is possible to facilitate adjustment of constraint conditions regarding joint delivery.

The delivery assistance system 20 presents the constraint conditions and the variations side by side in descending order of the variation. That is, for example, the delivery assistance system 20 may present the constraint conditions and the variations side by side in descending order of effectiveness.

The delivery assistance system 20 estimates the index value of the index for each of the plurality of changes of the condition value for each of the plurality of constraint conditions.

The index may be at least one of the number of delivery means, the delivery cost, the delivery distance, the time required for the delivery, and the carbon dioxide emission amount. When the index is the number of trucks, adjustment can be performed so as to achieve joint delivery in which the number of trucks decreases. As the number of trucks decreases, traffic congestion can be suppressed. When the index is the delivery cost, adjustment can be performed so as to achieve joint delivery with a low delivery cost. When the index is the delivery distance, adjustment can be performed so as to achieve joint delivery with a short delivery distance. The shorter the delivery distance, the more traffic congestion can be suppressed. The shorter the time required for delivery, the more traffic congestion can be suppressed. By reducing the number of trucks, reducing the delivery cost, shortening the delivery distance, and shortening the time required for delivery, the carbon dioxide emission amount can be reduced. For example, in a case where the index is a carbon dioxide emission amount and the variation is a carbon dioxide reduction amount, it is possible to promote the use of the delivery method in consideration of the environment.

The delivery assistance system 20 acquires the expected amount of load for each consignor on each deliverable date. The delivery assistance system 20 estimates an index value of an index in a case where at least part of the amount of load in a specific time zone is delivered in time zones before and after the specific time zone with respect to the constraint condition of the delivery date and time among the plurality of constraint conditions. As a result, it is possible to facilitate adjustment of the constraint conditions regarding the joint delivery.

The delivery assistance system 20 receives a change in a condition value of the identified constraint condition. The user may be a user as a distribution company or a user as a consignor. For example, in a case where the user is a user as a distribution company, the delivery assistance system 20 makes a notification to the consignor in a case of receiving the change in the condition value of the identified constraint condition. As a result, the consignor can confirm that the change has occurred.

<Example of Comparably Presenting Index Value in Case where Condition Value of Predetermined Constraint Condition is Changed>

Next, an example of presenting the index value in a comparable manner in a case where the condition value of the predetermined constraint condition is changed will be described.

As described above, the acquisition unit 201 acquires a condition value of each of a plurality of constraint conditions regarding the joint delivery for each consignor.

As described above, the acquisition unit 201 may acquire the allowable degree of change in each of the plurality of constraint conditions for each consignor. The acquisition unit 201 may acquire information necessary for the estimation of the index value of the index by the estimation unit 202 for each consignor.

Next, the estimation unit 202 may estimate the index value of the index for the acquired condition value and the index value of the index in a case where the condition value of the predetermined constraint condition is changed. The predetermined constraint condition may be a constraint condition designated by the user or a predetermined constraint condition. The condition value of the predetermined constraint condition may be a condition value designated by the user or a predetermined constraint condition value. The range in which the condition value of the predetermined constraint condition is changed may be within a range of a degree of allowance of the consignor. The consignor whose predetermined constraint condition is changed is not particularly limited. For example, the consignor whose condition value of the predetermined constraint condition is changed may be a specific consignor. For example, the consignor whose condition value of the predetermined constraint condition is changed may be a consignor whose condition value of the constraint condition is estimated to have a large influence on the effect in the joint delivery. For example, the consignor whose condition value of the predetermined constraint condition is changed may be all the consignors.

As described in the example of presenting the change in the condition value of the constraint condition in the joint delivery, the estimation unit 202 may estimate the index value of the index in a case where the condition value of the constraint condition is changed in a plurality of ways.

As described in the example of presenting the change in the condition value of the constraint condition in the joint delivery, the estimation unit 202 may estimate the index value of the index in a case where the delivery date of part of load is changed.

The output control unit 204 presents the acquired condition value and index value of the predetermined constraint condition and the changed condition value and index value in a case where the condition value of the predetermined constraint condition is changed in a comparable manner. As an example of performing presentation in a comparable manner, the output control unit 204 may present the acquired condition value and index value of the predetermined constraint condition and the changed condition value and index value in a case where the condition value of the predetermined constraint condition is changed side by side. Alternatively, as an example of presenting the index value in a comparable manner, the output control unit 204 may present a variation of the index value. Since the method presented by the output control unit 204 is as described above, detailed description thereof will be omitted.

The output control unit 204 may further present the degree of allowance of the consignor for the predetermined constraint conditions.

The change reception unit 205 receives the change in the condition value of the predetermined constraint condition by the user. The method of receiving the change by the change reception unit 205 may be the same as that in the example described in the example of presenting the change in the condition value of the constraint condition in the joint delivery. As in the above-described example, in a case where the user is a user as a distribution company, the output control unit 204 may make a notification of the change.

### (Example of Receiving Change Content)

As described above, the predetermined constraint condition may be designated by the user. Therefore, the change reception unit 205 may receive designation of at least one of the plurality of constraint conditions by the user. Specifically, for example, the change reception unit 205 receives designation of a constraint condition by the user via the terminal device of the user. The terminal device of the user is, for example, the terminal device 22 of a distribution company or the terminal device 21 of a consignor.

The degree to which the condition value of the predetermined constraint condition is changed from the acquired condition value or the changed condition value may be designated by the user. The change reception unit 205 may receive designation of a condition value or a degree of change after the change in the predetermined constraint condition by the user. Specifically, for example, the change reception unit 205 may receive designation of a condition value or a degree of change after the change in the predetermined constraint condition by the user via the terminal device of the user. The terminal device of the user is, for example, the terminal device 22 of a distribution company or the terminal device 21 of a consignor.

Since the following description is as described above, detailed description is omitted.

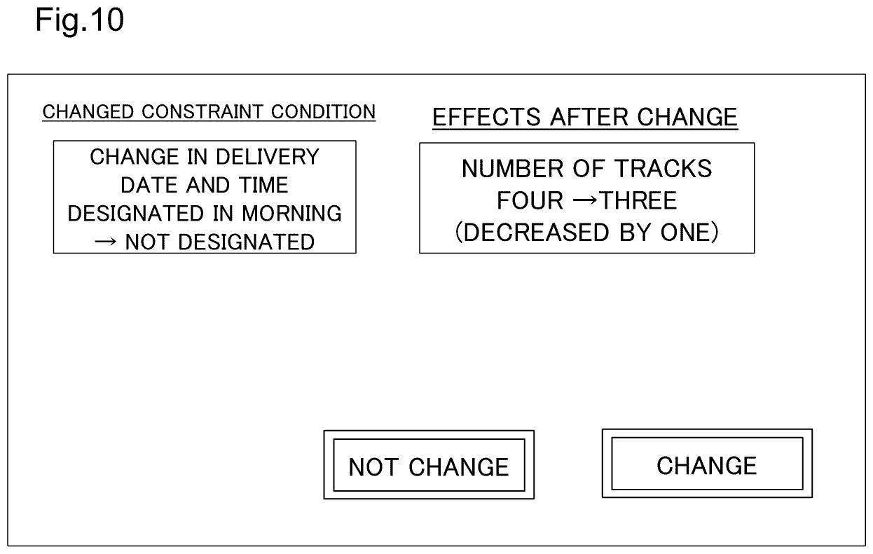

FIG. 10 is an explanatory diagram illustrating an example of presenting a change in a constraint condition and an index value. In FIG. 10, the delivery date and time is indicated as a predetermined constraint condition on the screen. In FIG. 10, the number of tracks is indicated as an index on the screen.

In FIG. 10, the screen exemplifies a case where the delivery date and time is changed from “designated in the morning” to “not designated”. In FIG. 10, in a case where the delivery date and time is “designated in the morning”, the number of trucks is four, and in a case where the delivery date and time is “not designated”, the number of trucks is three.

In FIG. 10, the screen includes a “not change” button and a “change” button. For example, when the “not change” button is pressed by the user, the condition value of the constraint condition is not changed. On the other hand, when the “change” button is pressed by the user, the change reception unit 205 receives a change in a condition value of a predetermined constraint condition. As described above, in a case where the user is a user as a distribution company, the output control unit 204 may make a notification of the change in a case where the change is received.

### (Another Flowchart Example)

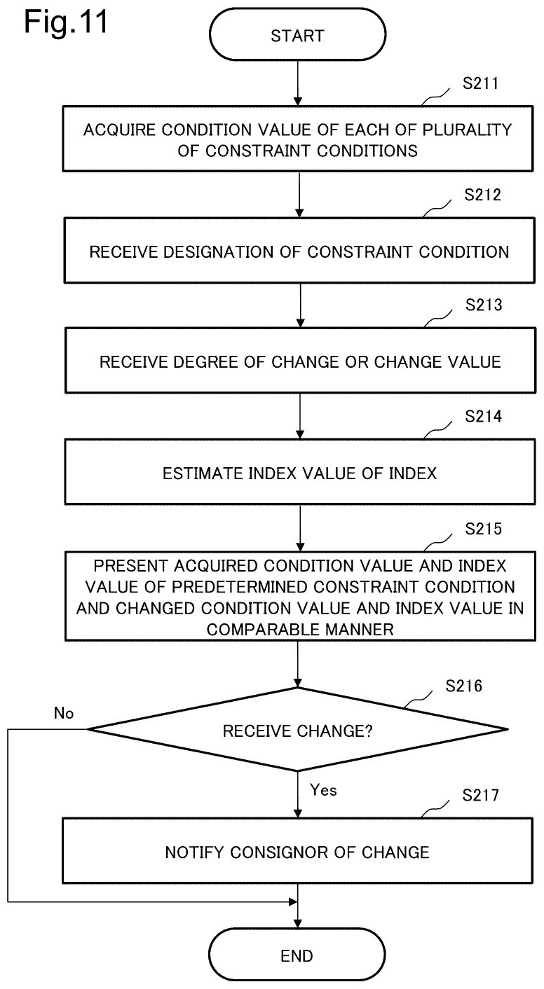

FIG. 11 is a flowchart illustrating an operation example of the delivery assistance system 20 according to the second example embodiment. A case where the user is a distribution company and a change by the distribution company is received will be described as an example.

The acquisition unit 201 acquires the condition value of each of the plurality of constraint conditions (step S211). In step S211, the acquisition unit 201 may acquire the condition value of each of a plurality of constraint conditions for each consignor.

The change content reception unit 206 receives designation of a constraint condition (step S212). In step S212, for example, the change content reception unit 206 receives the designation of the constraint condition via the terminal device 22 of the distribution company. The change content reception unit 206 sets the designated constraint condition as a predetermined constraint condition.

The change content reception unit 206 receives the degree of change or the change value of the condition value of the constraint condition (step S213). In step S213, the change content reception unit 206 receives the degree of change or the change value of the condition value of the constraint condition via the terminal device 22 of the distribution company.

The estimation unit 202 estimates the index value of the index for the acquired condition value and the index value of the index in a case where the acquired condition value for the predetermined constraint condition is changed (step S214). In step S214, for example, the estimation unit 202 estimates the index value for the acquired condition value. In step S213, for example, the index value in a case where the condition value of the predetermined constraint condition is changed from the acquired condition value is estimated.

The output control unit 204 presents the acquired condition value and index value of the predetermined constraint condition and the changed condition value and index value in a case where the condition value of the predetermined constraint condition is changed in a comparable manner (step S215).

The change reception unit 205 determines whether the change in the condition value of the identified constraint condition has been received (step S216). In step S216, for example, the change reception unit 205 determines whether the change in the condition value of the constraint condition by the distribution company was received via the terminal device 22 of the distribution company.

In a case where the change reception unit 205 receives the change (step S216: Yes), the output control unit 204 notifies the consignor of the change (step S217). The delivery assistance system 20 ends the process. On the other hand, in a case where the change reception unit 205 has not received the change (step S216: No), the delivery assistance system 20 ends the process.

As described above, in the second example embodiment, the delivery assistance system 20 estimates the index value of the index for the condition value of each of the plurality of constraint conditions and the index value of the index in a case where the acquired condition value for the predetermined constraint condition is changed. The delivery assistance system 20 presents the acquired condition value of the predetermined constraint condition and the index value in this case and the changed condition value of the predetermined constraint condition and the index value in this case in a comparable manner. In this manner, the effect at the time of changing the constraint condition is presented to the user. As a result, adjustment of the constraint conditions can be facilitated.

The delivery assistance system 20 may receive designation of a constraint condition in which a condition value is changed. As a result, the user can designate a constraint condition to be adjusted. In this manner, the user can actively try to change the condition value of the constraint condition. Therefore, it is possible to facilitate adjustment of the constraint conditions.

The delivery assistance system 20 may receive a degree of change or a change value. As a result, the user can designate the degree of change or the change value of the constraint condition to be adjusted. In this manner, the user can actively try to change the condition value of the constraint condition. Therefore, it is possible to facilitate adjustment of the constraint conditions.

An example of presenting the change in the condition value of the constraint condition in the joint delivery and an example of presenting the index value of the index in a case where the condition value of the predetermined constraint condition is changed in a comparable manner may be appropriately combined.

The description of the second example embodiment ends. Each example embodiment may be modified and used. The modifications will be described below.

### <First Modification>

For example, the estimation unit 202 may estimate the index value of the index in a case where the acquired condition value is changed for at least some of the plurality of constraint conditions.

A case where the condition value of the delivery date and time and the condition value of the delivery course are changed will be described as an example. For example, the estimation unit 202 may estimate an index value before changing the condition value of the constraint condition and an index value in a case where both the condition value of the delivery date and time and the condition value of the delivery course are changed. For example, the estimation unit 202 may estimate an index value before changing the condition value of the constraint condition, an index value in a case where the condition value of the delivery date and time is changed, an index value in a case where the condition value of the delivery course is changed, and an index value in a case where both the condition value of the delivery date and time and the condition value of the delivery course are changed.

Furthermore, there may be a plurality of cases where the condition value of the delivery date and time is changed, a plurality of cases where both the condition value of the delivery date and time and the condition value of the delivery course are changed, and a plurality of cases where the condition value of the delivery course is changed, and there is no particular limitation.

The description of the modification is ended. Each example embodiment and each modification may be used in combination. In each example embodiment, the delivery assistance system may include each function unit and part of information. For example, the delivery assistance system 20 may include the acquisition unit 201, the estimation unit 202, and the output control unit 204. Alternatively, for example, the delivery assistance system 20 may include the acquisition unit 201, the estimation unit 202, the output control unit 204, and the change reception unit 205.

The example embodiments are not limited to the examples described above, and various modifications can be made. The configuration of the delivery assistance system in each example embodiment is not particularly limited. For example, the delivery assistance system 20 may be achieved by a single device such as one terminal device or one server (for example, the delivery assistance device). Alternatively, the delivery assistance system in each example embodiment may be achieved by different devices for each function or data. For example, the delivery assistance system 20 may include a plurality of servers.

In each example embodiment, each piece of information may include part of the information described above. Each piece of information may include information other than the above-described information. Each piece of information may be divided into a plurality of tables or a plurality of pieces of information in more detail. As described above, a method of achieving each piece of information is not particularly limited.

Each screen is an example, and is not particularly limited. In each screen, a button, a list, a checkbox, an information display field, an input field, and the like (not illustrated) may be added. The background color of the screen and the like may be changed.

For example, in each example embodiment, for example, the processing of generating information or the like of a screen to be displayed on the terminal device may be performed by the output control unit of the delivery assistance system. This processing may be performed by the terminal device.

### (Hardware Configuration Example of Computer)

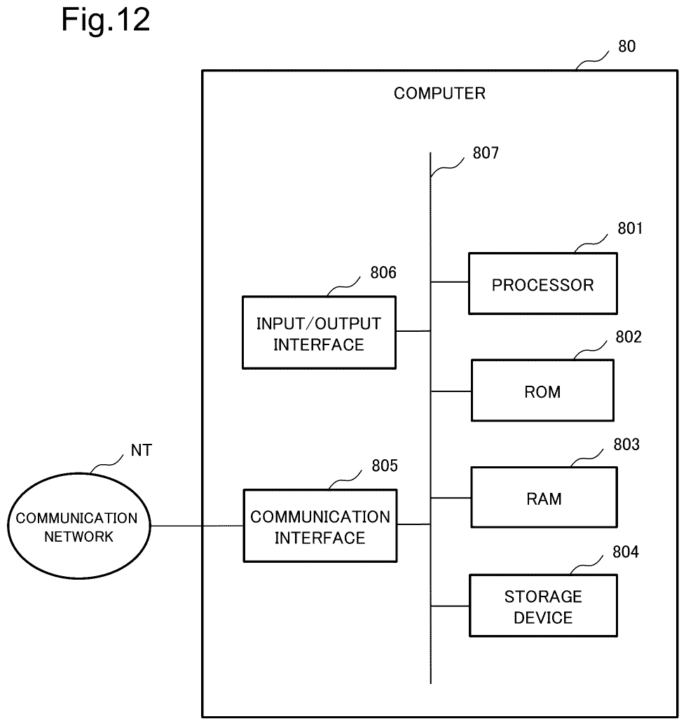

Next, a hardware configuration example in a case where devices such as the delivery assistance system, the terminal device of the consignor, and the terminal device of the distribution company described in each example embodiment are achieved by a computer will be described. FIG. 12 is an explanatory diagram illustrating a hardware configuration example of a computer. For example, some or all of the devices can be achieved using an any combination of a computer 80 and the program as illustrated in FIG. 12, for example.

The computer 80 includes, for example, a processor 801, a read only memory (ROM) 802, a random access memory (RAM) 803, and a storage device 804. The computer 80 includes a communication interface 805 and an input/output interface 806. The components are connected via a bus 807. The number of each component is not particularly limited, and each component is one or more.

The processor 801 controls the entire computer 80. Examples of the processor 801 include a central processing unit (CPU), a digital signal processor (DSP), and a graphics processing unit (GPU). The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. The RAM 803 is used as a work area of the processor 801.

The processor 801 loads a program stored in the storage device 804, the ROM 802, or the like. The processor 801 executes each process coded in the program. The processor 801 may download various programs via the communication network NT. The processor 801 functions as part or all of the computer 80. The processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. The communication interface 805 controls an input/output of data from the external device or the external computer 80.

The input/output interface 806 is connected to at least one of an input device, an output device, and an input/output device. The connection method may be wireless or wired. Examples of the input device include a keyboard, a mouse, and a microphone. Examples of the output device include a display device, a lighting device, and a speaker that outputs sound. Examples of the input/output device include a touch panel display. The input device, the output device, the input/output device, and the like may be built in the computer 80 or may be externally attached.

The hardware configuration of the computer 80 is an example. The computer 80 may have some components illustrated in FIG. 12. The computer 80 may have components other than those illustrated in FIG. 12. For example, the computer 80 may include a drive device or the like. The processor 801 may read a program or data stored in a recording medium attached to a drive device or the like into the RAM 803. Examples of the non-transitory tangible recording medium include an optical disk, a flexible disk, a magnetic optical disk, and a universal serial bus (USB) memory. As described above, for example, the computer 80 may include an input device such as a keyboard and a mouse. The computer 80 may include an output device such as a goods display. The computer 80 may include an input device, an output device, and an input/output device.

The computer 80 may include various sensors (not illustrated). The type of the sensor is not particularly limited.

The description of the hardware configuration of each device ends. There are various modifications in a method of achieving each device. For example, each device may be achieved by an any combination of a computer and a program different for each component. A plurality of components included in each device may be achieved by any combination of one computer and a program.

Part or all of each component of each device may be achieved by an application specific circuit. Part or all of each component of each device may be achieved by a general-purpose circuit including a processor such as a field programmable gate array (FPGA). Part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where part or all of each component of each device is achieved by a plurality of computers, circuits, and the like, the plurality of computers, circuits, and the like may be disposed in a centralized manner or in a distributed manner.

The delivery assistance method described in each example embodiment is implemented by the delivery assistance system. For example, the delivery assistance method is implemented by a computer such as a server or a terminal device executing a program prepared in advance. The program described in each example embodiment is recorded in a computer-readable recording medium such as an HDD, an SSD, a flexible disk, an optical disk, a flexible disk, a magnetic optical disk, or a USB memory. The program is executed by being read from the recording medium by the computer. The program may be distributed via the communication network NT.

Each component of the delivery assistance system in each example embodiment described above may be achieved as hardware like a computer. Alternatively, each component may be achieved by a computer or firmware based on program control.

While the present disclosure has been particularly shown and described with reference to each of example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### (Supplementary Note 1)

A delivery assistance system including
an acquisition means for acquiring a condition value of each of a plurality of constraint conditions related to joint delivery,
an estimation means for estimating an index value, of an index related to joint delivery, for the acquired condition value and an index value of the index in a case where the acquired condition value is changed for each of the plurality of constraint conditions,
an identification means for identifying a constraint condition in which a variation of the estimated index values meets a predetermined criterion among the plurality of constraint conditions, and
an output control means for presenting the identified constraint condition and the variation to a user.

### (Supplementary Note 2)

The delivery assistance system according to Supplementary Note 1, wherein
the output control means presents the constraint conditions and the variations of the index values side by side in descending order of the variations of the index values.

### (Supplementary Note 3)

The delivery assistance system according to Supplementary Note 1 or 2, wherein
the estimation means estimates, for each of the plurality of constraint conditions, index values of the index for a case where the acquired condition value is changed in a plurality of ways.

### (Supplementary Note 4)

The delivery assistance system according to any one of Supplementary Notes 1 to 3, wherein
the index is at least one of the number of delivery means, a delivery cost, a delivery distance, and a time required for delivery in the joint delivery.

### (Supplementary Note 5)

The delivery assistance system according to any one of Supplementary Notes 1 to 3, wherein
the index is a carbon dioxide emission amount, and
the variation is a carbon dioxide reduction amount.

### (Supplementary Note 6)

The delivery assistance system according to any one of Supplementary Notes 1 to 5, wherein
the acquisition means acquires, for each consignor, an expected amount of load for a deliverable date, and
the estimation means
estimates an index value of the index in a case where a time zone in which at least part of the load on a specific date is delivered is changed for a delivery date and time among the plurality of constraint conditions.

### (Supplementary Note 7)

The delivery assistance system according to any one of Supplementary Notes 1 to 6, wherein
the user is a user as a distribution company,
the delivery assistance system further includes
a change reception means for receiving a change in a condition value of the identified constraint condition by the user, and
the output control means makes a notification to the consignor in a case where the change is received.

### (Supplementary Note 8)

The delivery assistance system according to any one of Supplementary Notes 1 to 6, wherein
the user is a user as a consignor, and
the delivery assistance system further includes a change reception means for receiving a change in a condition value of the identified constraint condition by the user.

### (Supplementary Note 9)

A delivery assistance method including
acquiring a condition value of each of a plurality of constraint conditions related to joint delivery,
estimating an index value, of an index related to joint delivery, for the acquired condition value and an index value of the index in a case where the acquired condition value is changed for each of the plurality of constraint conditions,
identifying a constraint condition in which a variation of the estimated index values meets a predetermined criterion among the plurality of constraint conditions, and
presenting the identified constraint condition and the variation of the index values to a user.

### (Supplementary Note 10)

A non-transitory computer-readable recording medium that records a program for causing a computer to execute the steps of
acquiring a condition value of each of a plurality of constraint conditions related to joint delivery,
estimating an index value, of an index related to joint delivery, for the acquired condition value and an index value of the index in a case where the acquired condition value is changed for each of the plurality of constraint conditions,
identifying a constraint condition in which a variation of the estimated index values meets a predetermined criterion among the plurality of constraint conditions, and
presenting the identified constraint condition and the variation of the index values to a user.

### (Supplementary Note 11)

A program for causing a computer to execute the steps of
acquiring a condition value of each of a plurality of constraint conditions related to joint delivery,
estimating an index value, of an index related to joint delivery, for the acquired condition value and an index value of the index in a case where the acquired condition value is changed for each of the plurality of constraint conditions,
identifying a constraint condition in which a variation of the estimated index values meets a predetermined criterion among the plurality of constraint conditions, and
presenting the identified constraint condition and the variation of the index values to a user.

### REFERENCE SIGNS LIST

10, 20 delivery assistance system
101, 201 acquisition unit
102, 202 estimation unit
103, 203 identification unit
104, 204 output control unit
205 change reception unit
206 change content reception unit
2001 load DB
21, 21-1, 21-2 terminal device of consignor
22 terminal device of distribution company
80 computer
801 processor
802 ROM
803 RAM
804 storage device
805 communication interface
806 input/output interface
807 bus
A, B, C consignor

What is claimed is:

1. A delivery assistance system comprising:
a memory storing instructions; and
at least one processor configured to execute the instructions to:
acquire a condition value of each of a plurality of constraint conditions related to joint delivery;
estimate an index value, of an index related to joint delivery, for the acquired condition value and an index value of the index in a case where the acquired condition value is changed for each of the plurality of constraint conditions;
identify a constraint condition in which a variation of the estimated index values meets a predetermined criterion among the plurality of constraint conditions; and
present the identified constraint condition and the variation of the index values to a user.

2. The delivery assistance system according to claim 1, wherein the at least one processor is further configured to execute the instructions to:
present the constraint conditions and the variations of the index values side by side in descending order of the variations of the index values.

3. The delivery assistance system according to claim 1, wherein the at least one processor is further configured to execute the instructions to:
estimate, for each of the plurality of constraint conditions, index values of the index for a case where the acquired condition value is changed in a plurality of ways.

4. The delivery assistance system according to claim 1, wherein
the index is at least one of the number of delivery means, a delivery cost, a delivery distance, and a time required for delivery in the joint delivery.

5. The delivery assistance system according to claim 1, wherein
the index is a carbon dioxide emission amount, and
the variation is a carbon dioxide reduction amount.

6. The delivery assistance system according to claim 1, wherein the at least one processor is further configured to execute the instructions to:
acquire, for each consignor, an expected amount of load for a deliverable date, and
estimate an index value of the index in a case where a time zone in which at least part of the load on a specific date is delivered is changed for a delivery date and time among the plurality of constraint conditions.

7. The delivery assistance system according to claim 1, wherein
the user is a user as a distribution company, the at least one processor is further configured to execute the instructions to:
receive a change in a condition value of the identified constraint condition by the user, and
make a notification to the consignor in a case where the change is received.

8. The delivery assistance system according to claim 1, wherein
the user is a user as a consignor, and wherein the at least one processor is further configured to execute the instructions to:
receive a change in a condition value of the identified constraint condition by the user.

9. A delivery assistance method comprising:
acquiring a condition value of each of a plurality of constraint conditions related to joint delivery;
estimating an index value, of an index related to joint delivery, for the acquired condition value and an index value of the index in a case where the acquired condition value is changed for each of the plurality of constraint conditions;
identifying a constraint condition in which a variation of the estimated index values meets a predetermined criterion among the plurality of constraint conditions; and
presenting the identified constraint condition and the variation of the index values to a user.

10. A non-transitory computer-readable recording medium that records a program for causing a computer to execute the steps of:
acquiring a condition value of each of a plurality of constraint conditions related to joint delivery;
estimating an index value, of an index related to joint delivery, for the acquired condition value and an index value of the index in a case where the acquired condition value is changed for each of the plurality of constraint conditions;
identifying a constraint condition in which a variation of the estimated index values meets a predetermined criterion among the plurality of constraint conditions; and
presenting the identified constraint condition and the variation of the index values to a user.
